(19) United States
(12) Patent Application Publication
(10) Pub. No.: US 2024/0397556 A1
(43) Pub. Date: Nov. 28, 2024

(54) METHOD FOR INITIAL ACCESS TO SUPPORT REDCAP UE USING RESTRICTED PRACH OCCASIONS SHARED WITH NR UE

(71) Applicant: Nokia Technologies Oy, Espoo (FI)

(72) Inventors: Nitin MANGALVEDHE, Hoffman Estates, IL (US); Rapeepat RATASUK, Hoffman Estates Inverness, IL (US)

(21) Appl. No.: 18/696,029

(22) PCT Filed: Oct. 1, 2021
(86) PCT No.: PCT/US2021/053095

§ 371 Date: Mar. 27, 2024

(51) Int. Cl. H04W 74/0833

(52) U.S. Cl. CPC H04W 74/0833

(57) ABSTRACT

A method including receiving, by the network device from a user equipment (UE), a physical random-access channel (PRACH) message during a random-access channel (RACH) occasion (RO) in a PRACH slot, wherein the RO is associated with two or more Synchronization Signal Blocks (SSBs) and transmitting, by the network device to the UE, a random access response (RAR) message using two or more beams, wherein the two or more beams are associated with the two or more SSBs.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

In a general aspect, a device, a system, a non-transitory computer-readable medium (having stored thereon computer executable program code which can be executed on a computer system), and/or a method can perform a process with a method including receiving, by the network device from a user equipment (UE), a physical random-access channel (PRACH) message during a random-access channel (RACH) occasion (RO) in a PRACH slot, wherein the RO is associated with two or more Synchronization Signal Blocks (SSBs) and transmitting, by the network device to the UE, a random access response (RAR) message using two or more beams, wherein the two or more beams are associated with the two or more SSBs.

Implementations can include one or more of the following features. For example, the PRACH message comprises a PRACH preamble associated with the two or more SSBs, method can further include, after receiving the PRACH message, configuring, by the network device, two or more beams corresponding to each of the two or more SSBs, to separately detect the PRACH preamble. The method can further include receiving, by the network device from the UE, a second message in response to transmitting the RAR message, the second message including a UE type indication and determining, by the network device, one beam of the two or more beams to be used for future transmissions to, and receptions from, the UE based on the UE type indication being included in the second message. A first SSB of the two or more SSBs is mapped to a PRACH preamble in a RO for a new radio (NR) UE and a second SSB of the two or more SSBs is mapped to a PRACH preamble in the RO for a reduced capability UE.

The UE can be a reduced capability UE, the UE type indication can be a reduced capability UE type indication and the UE type indication is a reduced capability UE type indication. The RAR message transmitted on the two or more beams can include a same RAR information and wherein the RAR message can be transmitted on the two or more beams in different windows in time for different UE types. The method can further include transmitting, by the network device, a signal indicating that the RAR message will be transmitted using a determined beam. The second message is received, and each of the two or more beams can be used to separately the received second message (the second message is sometimes called Msg3). The determining of the one beam of the two or more beams can include determining an SSB associated with a best beam dependent on the presence or absence of a UE type indication. The RAR message transmitted on the two or more beams can include a same RAR information.

In another general aspect, a device, a system, a non-transitory computer-readable medium (having stored thereon computer executable program code which can be executed on a computer system), and/or a method can perform a process with a method including receiving, by a user equipment (UE), physical random-access channel (PRACH) configuration information comprising a first set of random-access channel (RACH) occasion (RO)s in a PRACH slot including at least two ROs for a first uplink bandwidth part and a first mapping comprising information at least associating a first Synchronization Signal Block (SSB) with a first RO belonging to the first set of ROs, determining, by the UE, a second set of ROs in the PRACH slot including at least one RO, wherein the second set of ROs is for a second uplink bandwidth part and wherein the bandwidth of the second uplink bandwidth part is smaller than the bandwidth of the first uplink bandwidth part and wherein the second set of ROs is a subset of the first set of ROs, determining, by the UE, a second mapping comprising information at least associating the first SSB with a second RO belonging to the second set of ROs when the first RO belonging to the first set of ROs is not comprised within the second set of ROs, and selecting, by the UE, a RO in which to transmit a PRACH message for indicating the first SSB, wherein the RO is selected based on the second mapping.

Implementations can include one or more of the following features. For example, the first mapping comprises information associating a second SSB with the second RO. Determining the second mapping can include determining, by the UE, a number of ROs in the first set of ROs and a number of SSBs per RO based on the PRACH configuration information and determining the number of SSBs mapped to all ROs in the PRACH slot based on the PRACH configuration information. The UE can be a reduced capability UE and the PRACH configuration information can be associated with a new radio (NR) UE. The second set of ROs in the PRACH slot is indicated by higher layer signaling.

Determining the second mapping can include determining, by the UE, a number of ROs in the second set of ROs based on a number of ROs contained within the second uplink (UL) bandwidth-part (BWP). The second mapping can include first, associating at least one SSB with at least one RO in the second set of ROs using preambles in increasing order of preamble indexes up to a maximum of a number of SSBs per RO based on the first mapping, wherein the preamble indexes are not used in the first mapping and second, associating the at least one SSB with the at least one RO in the second set of ROs in increasing order of indexes of the at least one RO in the second set of ROs. When a plurality of SSBs are mapped to the second RO, associating different SSBs of the plurality of SSBs with different PRACH preamble subsets. More SSBs can be associated with the second RO than with the first RO.

When the first SSB is determined by the UE to be the best SSB, initiating, by the UE, a random access procedure by transmitting a PRACH preamble in the second RO for indicating the first SSB. When a plurality of SSBs are mapped to the second RO, receiving a plurality of RARs, wherein each RAR of the plurality of RARs is associated with an SSB of the plurality of SSBs. The method can further include receiving, by the UE, a Radio Access Response (RAR) message transmitted using a beam associated with an SSB, where the SSB is associated with a RO according to the second mapping, and in response to receiving the RAR message, transmitting a message including a UE type indication.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating a RACH occasion (RO) associated with a Synchronization Signal Block (SSB) that does not fall inside a user equipment (UE) initial uplink (UL) bandwidth part (BWP) according to an example embodiment.

FIG. 3 is a diagram illustrating the mapping of multiple SSBs to a RO with different preamble subsets according to an example embodiment.

FIG. 4 is a diagram illustrating the mapping of SSBs to ROs for RedCap UEs and NR UEs including preamble partitions according to an example embodiment.

FIG. 5 is a flow diagram according to an example embodiment.

FIG. 6 is a block diagram of a method of operating a network device according to an example embodiment.

FIG. 7 is a block diagram of a method of operating a UE according to an example embodiment.

FIG. 8 is a block diagram of a wireless station or wireless node (e.g., AP, BS, gNB, RAN node, relay node, UE or user device, network node, network entity, DU, CU-CP, CU-CP, . . . or other node) according to an example embodiment.

### DETAILED DESCRIPTION

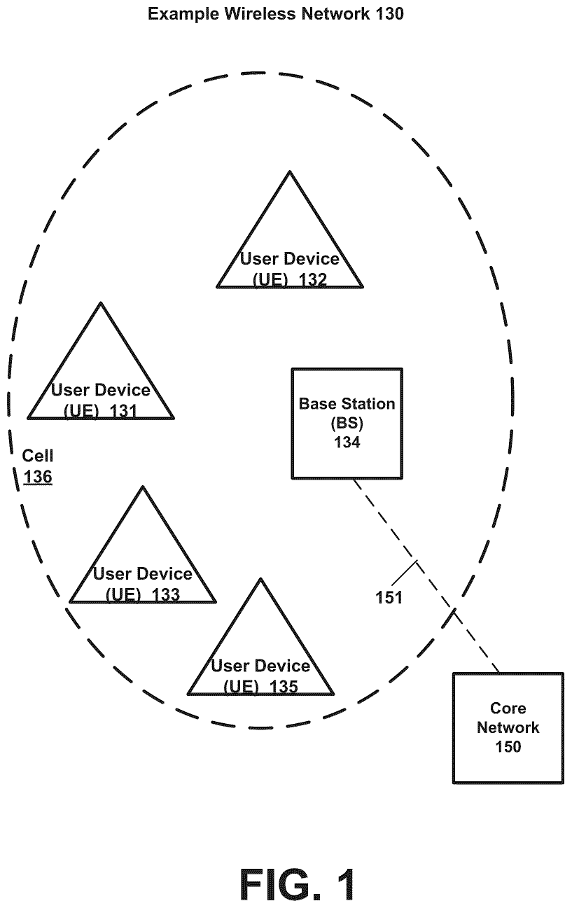

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (e)Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node. For example, a BS (or gNB) may include: a distributed unit (DU) network entity, such as a gNB-distributed unit (gNB-DU), and a centralized unit (CU) that may control multiple DUs. In some cases, for example, the centralized unit (CU) may be split or divided into: a control plane entity, such as a gNB-centralized (or central) unit-control plane (gNB-CU-CP), and an user plane entity, such as a gNB-centralized (or central) unit-user plane (gNB-CU-UP). For example, the CU sub-entities (gNB-CU-CP, gNB-CU-UP) may be provided as different logical entities or different software entities (e.g., as separate or distinct software entities, which communicate), which may be running or provided on the same hardware or server, in the cloud, etc., or may be provided on different hardware, systems or servers, e.g., physically separated or running on different systems, hardware or servers.

As noted, in a split configuration of a gNB/BS, the gNB functionality may be split into a DU and a CU. A distributed unit (DU) may provide or establish wireless communications with one or more UEs. Thus, a DUs may provide one or more cells, and may allow UEs to communicate with and/or establish a connection to the DU in order to receive wireless services, such as allowing the UE to send or receive data. A centralized (or central) unit (CU) may provide control functions and/or data-plane functions for one or more connected DUs, e.g., including control functions such as gNB control of transfer of user data, mobility control, radio access network sharing, positioning, session management etc., except those functions allocated exclusively to the DU. CU may control the operation of DUs (e.g., a CU communicates with one or more DUs) over a front-haul (Fs) interface.

According to an illustrative example, in general, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU, . . . ) may forward data to the UE that is received from a network or the core network, and/or forward data received from the UE to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM) (which may be referred to as Universal SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network (e.g., which may be referred to as 5GC in 5G/NR).

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), massive MTC (mMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The various example embodiments may be applied to a wide variety of wireless technologies or wireless networks, such as LTE, LTE-A, 5G (New Radio (NR)), cmWave, and/or mmWave band networks, IoT, MTC, eMTC, mMTC, eMBB, URLLC, etc., or any other wireless network or wireless technology. These example networks, technologies or data service types are provided only as illustrative examples.

In a connected mode (e.g., RRC-Connected) with respect to a cell (or gNB or DU), the UE is connected to a BS/gNB, and the UE may receive data, and may send data (based on receiving an uplink grant). Also, in a connected mode, UE mobility may be controlled by the gNB or network.

In order to conserve power, a UE may, for example, transition from a connected state (e.g., RRC_Connected) to an unconnected state, such as an Idle state (e.g., RRC_Idle) or Inactive state (e.g., RRC_Inactive), e.g., in which the UE may sleep (a low power state) much of the time while in Idle or Inactive state. In Idle state or Inactive state, the UE does not have a connection established with any cell, and mobility (e.g., determining which cell the UE will be camped on or which cell to select as the serving cell for the UE) is controlled by the UE. Inactive state (e.g., RRC_Inactive) may also be referred to as a suspended state of the UE. While in Idle state or Inactive state, the UE may sleep much of the time, and then periodically wake (e.g., changing from a low power state to a full-power state) to perform one or more tasks or processes, e.g., such as receiving system information from the cell the UE may be camped on (the serving cell for the UE while in Idle state or Inactive state), detecting a paging message (a paging message detected by the UE may indicate that the network has data for downlink transmission to the UE), and/or performing a cell search and cell reselection process in which the UE may measure reference signals from various cells, and then select a cell (or reselect the same cell) to camp on (as the serving cell), based on the received signals from various cells. Thus, as an example, cell selection may include selecting a cell that has a strongest reference signal received power (RSRP) and/or reference signal received quality (RSRQ), or other signal parameter. Thus, in Idle state or Inactive state, the serving cell may be referred to as the cell the UE has camped on. For example, a UE may typically receive system information (e.g., via receiving one or more broadcast system information blocks (SIBs)) from the serving cell (or the cell the UE is camping on) while the UE is awake in Idle state or Inactive state.

As noted, when a UE is in Idle state, there is no RRC context (the parameters necessary for communication between the UE and network) for the UE stored by the radio access network (BS/gNB) or UE. No uplink synchronization is maintained by the UE, and no data transfer may take place, as the UE sleeps most of the time to conserve battery consumption. The UE may wake periodically to receive paging messages and perform cell reselection, based on reference signal measurements. UE mobility is handled by the UE via cell reselection. An uplink transmission that may be performed by the UE in Idle mode is the random access (RACH) procedure or messages, that may be used for the UE to transition from Idle state to Connected state with respect to a cell or gNB.

In Inactive state, (at least some) RRC context for the UE is stored at both the UE and the gNB, e.g., to allow the UE to more quickly transition from Inactive state to Connected state, e.g., since at least some RRC context for the UE may already be in place at the UE and the gNB (e.g., such as an inactive-radio network temporary identifier (I-RNTI) assigned to the UE). At the same time, the Inactive UE is allowed to sleep (or enter a low power state), and periodically wake to receive paging messages and/or perform cell reselection, e.g., in a same or similar manner as Idle state.

As noted, a UE in Idle state or Inactive state may use a random access (RACH) procedure to transition to a Connected state. A random access (RACH) procedure may use a 4-step RACH procedure, or a 2-step RACH procedure (where some of the steps or messages in the 4-step RACH procedure may be combined). At step 1 (message 1 of the 4-step RACH procedure, for example), the UE transmits/sends a random access (RACH) preamble to the gNB/cell, which allows the network/gNB to estimate transmission timing for the UE. At step 2 (message 2), the gNB transmits a random access response (RAR) message to the UE, which may include a timing advance command to allow the UE to perform uplink (UL) synchronization with the cell or gNB, and an allocation of a relatively small amount of resources for the UE to use for uplink (UL) transmission of the message 3 (at step 3) of the RACH procedure. At step 3 of the RACH procedure, the UE may send a RACH control message, e.g., such as a Radio Resource Control (RRC) Resume Request (RRCResumeRequest) message, or a Radio Resource Control (RRC) Connection Request (RRCConnectionRequest) message, via the relatively small amount of resources provided via message 2. At step 4 (message 4 of the RACH procedure), the UE may receive from the gNB a contention resolution message to resolve any potential collisions. After receiving this message 4, the UE is connected with the cell or gNB, and the UE may then request and receive an UL grant (of resources) to allow the UE to transmit UL data to the cell or gNB.

The random access procedure can be performed within the UL initial bandwidth part (BWP) and the DL initial BWP configured in the system information block (SIB). The SIB provides a RACH configuration, which defines RACH occasions (ROs), which can be used for transmission of the PRACH preamble for initiating the random access procedure. The ROs can be configured within the initial UL BWP. The RACH configuration can provide the time configuration, frequency configuration, and the number of PRACH preambles to be associated with each synchronization signal block (SSB). The specification allows up to 8 ROs to be contiguously multiplexed in the frequency domain within the initial UL BWP. The number of ROs (e.g., multiplexed ROs) can be indicated as a parameter in the RACH configuration. The specification also defines a rule for mapping SSBs to ROs and different preamble subsets when multiple SSBs are mapped to an RO (e.g., in FR1). A single SSB may also be mapped to multiple ROs (e.g., in FR1 and FR2).

Before initiating the random access procedure, the UE can measure all the SSBs and determines the best SSB (e.g., the SSB with the highest signal strength). The UE can determine the RO associated with the best SSB using the mapping rule. The UE can then select a PRACH preamble and transmit the PRACH preamble as Msg1 in the determined RO. The gNB can receives Msg1 and transmit a random access response (RAR) back to the UE as Msg2 within the RAR configuration window. In response to receiving the RAR, the UE can transmit Msg3.

Reduced Capability (RedCap) NR devices are being introduced in some 5G implementations. The RedCap devices can be characterized by complexity reduction features compared with NR devices. The reduced features can include a smaller number of receive antennas, a reduced bandwidth, and optional half-duplex operation. In particular, the bandwidth of RedCap devices can be limited to, for example, 20 MHz in FR1 and 100 MHz in FR2.

The initial UL BWP for the RedCap UE may not exceed the RedCap UE bandwidth defined in the standards. Furthermore, when the initial UL BWP for the NR UE (e.g., a non-RedCap UE) is configured to be wider than the RedCap UE bandwidth, a separate initial UL BWP may be configured for the RedCap UE. The RO associated with the best SSB can fall within the RedCap UE bandwidth. In other words, retuning away from the configured initial UL BWP for Msg1 transmission may not be supported. The ROs that are defined for the RedCap UEs can either be dedicated for RedCap UEs or shared with NR UEs. Although dedicated ROs can provide greater flexibility, dedicated ROs may also increase overhead. On the other hand, when ROs are shared between RedCap UEs and NR UEs, the frequency span of the ROs configured for NR UEs may exceed the RedCap UE bandwidth (even though some resources may be efficiently utilized).

With the possibility that the RACH configuration can include up to 8 ROs multiplexed in the frequency domain, a problem can be that the bandwidth occupied by the ROs may exceed the UE bandwidth. Therefore, with a fixed location of the RedCap UE BWP, some of the ROs (e.g., the RO associated with the best SSB) may not fall entirely within the UE bandwidth. If an RO is not inside the RedCap UE BWP, the UE will not be able to use this RO. To ensure that all ROs are within RedCap UE initial UL BWP, the bandwidth spanned by the ROs when they are shared between RedCap UEs and non-RedCap UEs may be restricted. However, this may problematically be unnecessarily limiting for non-RedCap UEs.

Example implementations may use the ROs that fall within the RedCap UE BWP as the ROs that are applicable to the RedCap UEs. For example, the RedCap UE may implicitly determine that all the ROs that are within the RedCaps initial UL BWP are valid ROs, even where the initial UL BWP may be configured to include one or more ROs from the RACH configuration for the non-RedCap UEs. According to an example implementation, the mapping of SSBs to ROs needs to be different for RedCap UEs because there may be fewer ROs available for their use compared with those indicated in the RACH configuration for the initial UL BWP of the non-RedCap UE.

SSB indexes can be mapped to valid ROs such that SS/PBCH block indexes provided by ssb-PositionsInBurst in SIB1 or in ServingCellConfigCommon are mapped to valid PRACH occasions (also known as RACH occasions, ROs) in the following order, first, in increasing order of preamble indexes within a single PRACH occasion, second, in increasing order of frequency resource indexes for frequency multiplexed PRACH occasions, third, in increasing order of time resource indexes for time multiplexed PRACH occasions within a PRACH slot, and fourth, in increasing order of indexes for PRACH slots.

An association period, starting from frame 0, for mapping SS/PBCH block (i.e., SSB) indexes to PRACH occasions is the smallest value in the set determined by the PRACH configuration period such that N_{Tx}^{SSB} SS/PBCH block indexes are mapped at least once to the PRACH occasions within the association period, where a UE obtains N_{Tx}^{SSB} from the value of ssb-PositionsInBurst in SIB1 or in ServingCellConfigCommon. If after an integer number of SS/PBCH block indexes to PRACH occasions mapping cycles within the association period there is a set of PRACH occasions or PRACH preambles that are not mapped to N_{Tx}^{SSB} SS/PBCH block indexes, no SS/PBCH block indexes are mapped to the set of PRACH occasions or PRACH preambles. An association pattern period includes one or more association periods and is determined so that a pattern between PRACH occasions and SS/PBCH block indexes repeats at most every 160 msec. PRACH occasions not associated with SS/PBCH block indexes after an integer number of association periods, if any, are not used for PRACH transmissions.

Example implementations can address issues including how are the SSBs associated with ROs for the non-RedCap UEs such that no conflict is created for the gNB when the same RO is associated with SSBs differently for RedCap and non-RedCap UEs based on the ROs in the RACH configuration that may be shared between RedCap UEs and on-RedCap UEs, and how are random access response (RAR) transmissions handled when different SSBs for RedCap UEs and non-RedCap UEs are associated with the same RO? Accordingly, example implementations describe a method for selecting ROs in the PRACH configuration for RedCap UEs and association of these ROs with SSBs where the same RO may be associated with different SSBs for RedCap UEs and non-RedCap UEs with shared PRACH preambles. Furthermore, example implementations describe a method for two random access responses when different SSBs for RedCap UEs and NR UEs are mapped to the same RO.

In an example implementation, the frequency span of the M1 frequency multiplexed ROs configured for an NR UE can exceed the RedCap UE bandwidth. Furthermore, the M2 ROs within the RedCap UE initial UL BWP that are valid for a RedCap UE can be shared with the NR UE and they are known to the RedCap UE either through explicit indication in system information or implicit determination (e.g., the frequency multiplexed ROs from the that are completely inside the initial UL BWP). The UE may determine the best SSB after measuring all the SSBs and identifying the SSB that was received with the highest power among all the SSBs for which the received power exceeds a pre-determined threshold. In an example implementation, either Msg1-based or Msg3-based early indication of RedCap UE type can be configured.

According to an example implementation, mapping of SSBs to valid ROs and preamble indexes in a single PRACH slot for the RedCap UE can include receiving, by the RedCapUE from a base station, a PRACH configuration for a NR UE, determining a number of SSBs per RO and a number of frequency-multiplexed ROs, and determining a number of SSBs mapped to all frequency-multiplexed ROs configured for the NR UE in one PRACH slot based on the PRACH configuration. Determining the number of valid frequency-multiplexed ROs for the RedCap UE in one PRACH slot such that the number of valid frequency-multiplexed ROs for the RedCap UE in one PRACH slot is smaller than the number of frequency-multiplexed ROs configured for the NR UE. The number of valid frequency-multiplexed ROs for the RedCap UE in one PRACH slot may be indicated by higher layer signaling or may be determined by the RedCap UE based on a number of frequency-multiplexed ROs within a RedCap UE initial UL BWP.

A mapping of the number of SSBs mapped to all frequency-multiplexed ROs configured for the NR UE in one PRACH slot to the number of valid frequency-multiplexed ROs for the RedCap UE may be determined. This mapping may include, first, in an increasing order of preamble indexes up to a maximum of the number of SSBs per RO for the NR UE (to replicate the mapping for NR UEs) and, second, in increasing order of frequency resources indexes (e.g., indexes of frequency-multiplexed ROs). The first and second steps can be repeated for any remaining SSBs, where the mapping in the repeated step is done for preamble indexes that are different from those in the original step. In an example implementation, multiple SSBs may be mapped to a single RO and be associated with different PRACH preamble subsets, similar to legacy. The mapping may associate more SSBs with a valid RO for the RedCap UE than for the NR UE. In addition, if Msg1-based early identification through PRACH preambles is configured for the RedCap UEs, different PRACH preamble partitions may be associated with the SSBs mapped to the RO for NR UEs and RedCap UEs. If Msg1-based early identification through PRACH preambles is not configured for the RedCap UEs, the same set of preambles may be associated with different SSBs for NR UEs and RedCap UEs.

The RedCap UE can determine the RO and the PRACH preamble indexes associated with the best SSB and initiate a random access procedure by transmitting a PRACH preamble in the RO. In any RO that is associated with multiple SSBs, the gNB can process the received PRACH preamble using the beam associated with each of the multiple SSBs. If each of the multiple SSBs mapped to the RO is associated with a different PRACH preamble partition, the gNB receiver may apply the unique beam corresponding to the associated SSB to detect the PRACH preambles within the partition (legacy behavior). If the two SSBs that are mapped to an RO for NR UEs and RedCap UEs are associated with a shared PRACH preamble, the gNB receiver may apply the beam corresponding to each of these SSBs to detect the same PRACH preamble. In response to a PRACH preamble received in an RO that is associated with two different SSBs for NR UEs and RedCap UEs and received with the corresponding two beams, the gNB can transmit a random access response (RAR) carrying the same content on both the beams. The RARs may be distinguishable for RedCap and NR UE based on, for example, the RAR window in which each RAR is transmitted.

In an example implementation, the gNB may transmit the RAR on a single beam based on the received powers of the PRACH preamble on the two beams satisfying a pre-determined condition. If the RedCap UE determines that two RARs may be transmitted based on the mapping of SSBs to ROs with shared PRACH preambles, the RedCap UE can attempt to decode both transmissions. Optionally, signaling can be supported to enable the UE to determine which transmission was sent on its best beam. The RedCap UE can transmit a Msg3 based on the UL grant in the RAR. If configured, an indication of RedCap UE type can be included in Msg3. If the gNB detects the PRACH preamble after processing the received signal using two beams, then the gNB can receive Msg3 using one beam or two beams based on the RAR transmission. If the RAR was transmitted using a single beam, the same beam can be used to receive Msg3.

If the RAR was transmitted using two beams, each of the beams can be used to separately process and decode the received Msg3. Furthermore, presence or absence of indication of RedCap UE type also determines the SSB associated with the best beam selected by the UE and hence the corresponding beam to be used in future transmissions and receptions. The gNB may not know which is the right beam for receiving Msg3. If the gNB assumes the wrong beam, the gNB may fail to successfully decode Msg3. Therefore, the gNB can use each of the two beams to separately receive Msg3.

In an example implementation, the mapping of SSBs to valid ROs for the RedCap UE can depend on the number of valid ROs within the RedCap UE UL BWP. For example, the number of SSBs that are mapped to all the frequency multiplexed ROs in a single PRACH slot configured for the NR UE can be determined as L=M1×N1 where M1 is the value configured for the higher layer parameter msg1-FDM and N1 is the value configured for the higher layer parameter ssb-perRACH-Occasion. The L SSBs can be mapped to the M2 frequency multiplexed valid ROs within the RedCap UE initial UL BWP based on an implicit determination or an explicit configuration. Implicitly, the number of SSBs per RO for the RedCap UE may be determined as N2=┌L/M2┐. Alternatively, a separate value N2 may be explicitly configured for the RedCap UE. If K1 is the value configured by the higher layer parameter CB-PreamblesPerSSB, the corresponding value for the RedCap UE is determined as K2=K1×N1/N2.

The mapping of L SSBs to frequency-multiplexed resources in a single PRACH slot can be done in an order including, first, in increasing order of preamble indexes, for N1 SSBs, within a single RO, second, in increasing order of frequency resource indexes for frequency-multiplexed ROs. For any remaining SSBs, the first and second steps can be repeated, where the mapping in the repeated step is done for preamble indexes that are different from those in the original step. If the gNB transmits an RAR on two different beams, the RAR transmissions on the two beams can be sequential. If different RAR windows are configured for NR and RedCap UEs, one RAR can be transmitted within the RAR window for the RedCap UE and the other RAR can be transmitted within the RAR window for the NR UE.

The RAR transmissions on the two beams can be concurrent through power splitting. If different RAR windows are configured for NR and RedCap UEs, the RAR can be transmitted within the overlapping region of the RAR windows configured for the NR UE and the RedCap UE. Orthogonal DMRS sequences may be used for the transmissions on the two beams. Since coverage of RAR can be reduced from power splitting between the two beams, this approach may be applied if a 3-dB coverage margin is available for the RAR PDCCH and PDSCH or a coverage recovery technique may be used for the transmissions.

The following represents an example implementation of different mapping of SSBs to ROs for RedCap UEs and NR UEs with shared PRACH preambles. For NR UE, SSB1 can be mapped to RO1 using all preambles (e.g., indexes 1-40). For RedCap UE, SSB1 can be mapped to RO1 (e.g., a same mapping as NR UE) but using only preamble subset 1 (e.g., indexes 1-20). SSB3 can be mapped to RO1 (different mapping than NR UE) and using only preamble subset 2 (e.g., indexes 21-40). Therefore, in RO1, the same preamble indexes 21-40 can be used to map SSB1 for NR UE and SSB3 for RedCap UE. In response to a PRACH preamble received in an RO (e.g., RO1) that is associated with two different SSBs for NR UEs and RedCap UEs (e.g., preamble indexes 21-40 correspond to SSB3 for RedCap UE and SSB1 for NR UE) and received with the corresponding two beams, the gNB can transmit a random access response (RAR) carrying the same content on both the beams (e.g., beams corresponding to SSB1 and SSB3).

When the RedCap UE determines that RARs are transmitted on two beams, the optional signaling to enable the UE to determine which transmission was sent on its best beam can be based on one of the following embodiments.

In a first embodiment, the UE may determine which transmission is sent on its best beam based on indication in the PDCCH.

In a second embodiment, the UE may determine which transmission is sent on its best beam based on encoding the SSB index information in the DMRS for the PDCCH scheduling the RAR or the PDSCH carrying the RAR.

If the gNB received the PRACH preamble using the beam corresponding to each of two different SSBs, the gNB may transmit a single RAR based on satisfying a condition. The condition can be whether the gNB received the PRACH preamble using the two beams with a power difference that is larger than a threshold T. If the condition is satisfied, the RAR can be transmitted on the beam corresponding to the higher power. This condition can also be used to determine whether the UE is a RedCap UE or an NR UE. If different RAR windows are configured for NR UEs and RedCap UEs, the RAR is transmitted within the appropriate window.

Advantages of example implementations can include, at least, enabling the sharing of ROs between RedCap UEs and NR UEs even with different number of frequency-multiplexed ROs and enabling remapping of SSBs to valid ROs for the RedCap UE with a PRACH slot, which can include a subset of the valid ROs for the NR UE, both with dedicated PRACH preambles for RedCap UEs and with PRACH preambles shared with NR UEs.

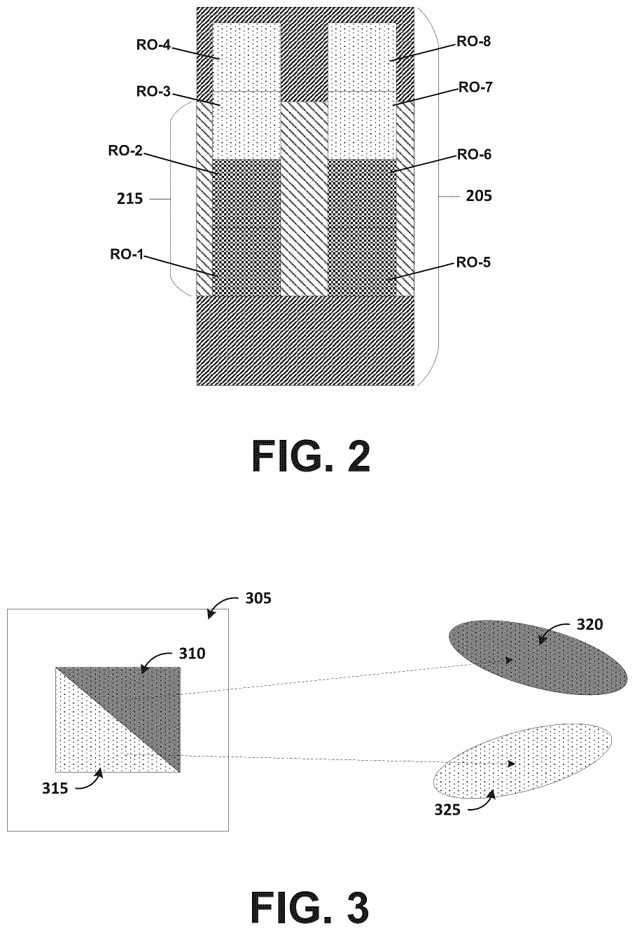

FIG. 2 is a diagram illustrating a RACH occasion (RO) associated with a Synchronization Signal Block (SSB) that does not fall inside a user equipment (UE) initial uplink (UL) bandwidth part (BWP) according to an example embodiment. As shown in FIG. 2, a plurality of ROs RO-1, RO-2, RO-3, RO-4, RO-5, RO-6, RO-7, RO-8 are illustrated as being within an initial UL BWP 205. However, a RedCap UE can have an initial UL BWP 215 that has a smaller bandwidth than a NR UE. Accordingly, RO-1, RO-2, RO-5, and RO-6 can be determined to be valid RO's for both the NR UE and the RedCap UE. In addition, RO-3, RO-4, RO-7, and RO-8 can be determined to be valid RO's for the NR UE and invalid (e.g., outside a usable bandwidth) RO's for the RedCap UE. Accordingly, RO-3, RO-4, RO-7, and RO-8 may not be used for the RedCap UE. Should any of RO-3, RO-4, RO-7, and RO-8 also be associated with a best SSB, RO-3, RO-4, RO-7, and RO-8 cannot be used to reference the corresponding beam. For example, should an SSB associated with RO-4 be determined to be the best SSB, RO-4 cannot be used to reference the corresponding beam. Therefore, example implementations can implement an alternative mapping scheme to reference the beam associated with the best SSB.

FIG. 3 is a diagram illustrating the mapping of multiple SSBs to a RO with different preamble subsets according to an example embodiment. As shown in FIG. 3, an RO 305 can include a first preamble subset 310 and a second preamble subset 315. The first preamble subset 310 can reference a first SSB 320 and the second preamble subset 315 can reference a second SSB 325. Although only two preamble subsets are illustrated, more than two preamble subsets are within the scope of this disclosure.

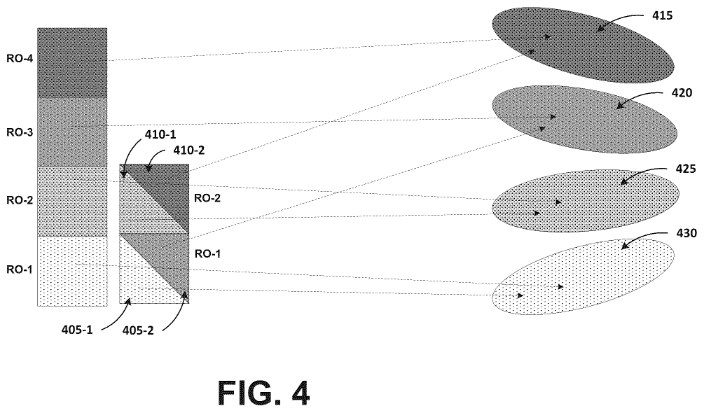

FIG. 4 is a diagram illustrating the mapping of SSBs to ROs for RedCap UEs and NR UEs including preamble partitions according to an example embodiment. As shown in FIG. 4, a plurality of ROs RO-1, RO-2, RO-3, RO-4 can reference a plurality of SSBs 415, 420, 425, 430. The plurality of ROs RO-1, RO-2, RO-3, RO-4 can be available for use by both a NR UE and a RedCap UE. However, ROs RO-1, RO-2, RO-3, RO-4 can be valid for the NR UE and ROs RO-1, RO-2 can be valid for the RedCap UE. In other words, ROs RO-1, RO-2 are within the RedCap UE operable frequency range whereas ROs RO-3, RO-4 are not within the RedCap UE operable frequency range.

Accordingly, in an example implementation, RO-1 can be mapped to SSB 430 for a NR UE and RO-1 can use preamble subsets for mapping ROs to SSBs for the RedCap UE. As illustrated in FIG. 4, RO-1 for a RedCap UE can have a first preamble subset 405-1 and a second preamble subset 405-2. Further, the first preamble subset 405-1 can be mapped to SSB 430 for the RedCap UE. RO-3 can be mapped to SSB 420 for a NR UE and according to an example implementation, the second preamble subset 405-2 can be mapped to SSB 420 for the RedCap UE.

RO-2 can be mapped to SSB 425 for the NR UE and RO-2 can use preamble subsets for mapping ROs to SSBs for the RedCap UE. As illustrated in FIG. 4, RO-2 can have a first preamble subset 410-1 and a second preamble subset 410-2. Further, the first preamble subset 410-1 can be mapped to SSB 425 for the RedCap UE. RO-4 can be mapped to SSB 415 for a NR UE and according to an example implementation, the second preamble subset 410-2 can be mapped to SSB 415 for the RedCap UE.

In an example implementation, the mapping can use separate preamble partitions as relates to the NR UE and the RedCap UE and/or the mapping can use shared PRACH preambles. In a first example embodiment, some of the preambles in RO-1 can be mapped to SSB 430 for a NR UE and comprise a separate partition from the preamble subsets 405-1 and 405-2 within the same RO that are mapped to SSB 430 and SSB 420, respectively, for RedCap UE. In an alternative example embodiment, all the preambles in RO-1 can be mapped to SSB 430 for a NR UE and can comprise the union of the preamble subsets 405-1 and 405-2 within the same RO that are mapped to SSB 430 and SSB 420, respectively, for RedCap UE. For example, if each of the SSBs mapped to the RO is associated with a different PRACH preamble partition, the gNB receiver may apply a unique beam corresponding to the associated SSB to receive the PRACH preambles within the partition (e.g., legacy behaviour). For example, if the two SSBs that are mapped to an RO for NR UEs and RedCap UEs are associated with a shared PRACH preamble, the gNB receiver may apply the beam corresponding to each of the SSBs to receive the same PRACH preamble.

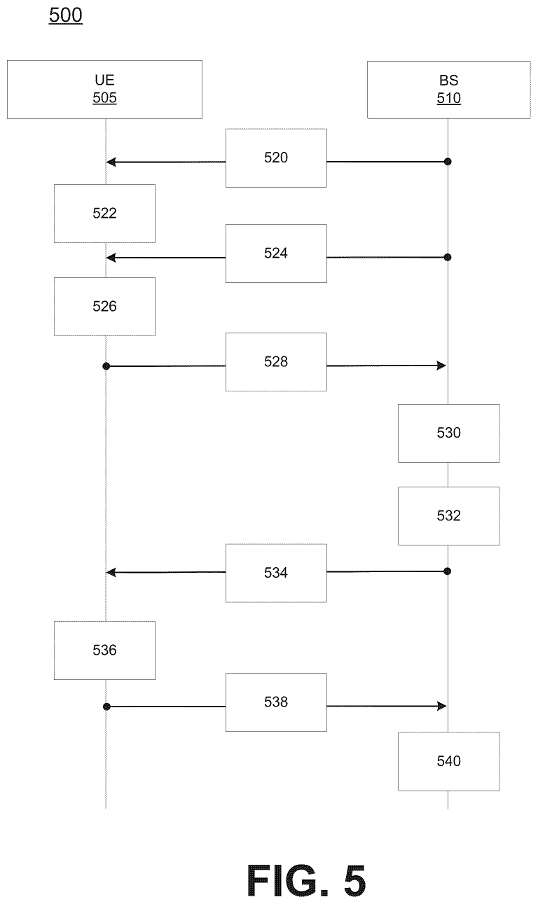

FIG. 5 is a flow diagram according to an example embodiment. As shown in FIG. 5, a signal flow 500 can include communications between a user equipment UE 505 and a bases station BS 510. The UE 505 can be a RedCap UE and the BS 510 can be a network device, a network node, a gNB, an eNB, and/or the like.

The BS 510 communicates a message 520 to the UE 505. The message 520 can include a plurality of Synchronization Signal Block(s) (SSBs) each referencing a beam associated with the BS 510. In block 522, the UE determines the best SSB. For example, the UE 505 can measure (e.g., signal power) all the SSBs and determines the best SSB (e.g., the highest power value). The BS 510 communicates a message 524 to the UE 505. The message 524 can include a RACH configuration in a signal information block (SIB) (e.g., SIB 1). For example, the SIB can provide a RACH configuration, which defines RACH occasions (ROs), which can be used for transmission of the PRACH preamble for initiating the random access procedure. The ROs can be configured within the initial UL BWP. The RACH configuration can provide the time configuration, frequency configuration, and the number of PRACH preambles to be associated with each SSB.

In block 526 the UE 505 can determine the RO associated with best SSB based on a rule for mapping of SSBs to ROs within one PRACH slot for UE (e.g., RedCap UE). The UE then selects a PRACH preamble and transmits (block 528) the PRACH preamble as Msg1 in the RO or PRACH preamble as part of MsgA when using 2-step RACH. The RO and the PRACH preamble is selected based on the mapping of the SSBs to the ROs. In block 530 the BS 510 processes the received PRACH preamble using one beam or two beams based on the mapping. In block 532 the BS 510 determines whether the best SSB is identifiable based on a condition. For example, if the BS 510 received the PRACH preamble using two or more beams with a power difference that is larger than a threshold T, the best SSB can be associated with the beam corresponding to the higher power.

The BS 510 communicates a message 534 to the UE 505. The message 534 can include an RAR. The message 534 (e.g., RAR) can be transmitted on a single beam or on two or more beams based on the mapping and the condition. For example, if the condition is met, and the best beam is determined, the message 534 (e.g., RAR) can be transmitted on a single beam. Otherwise, the message 534 (e.g., RAR) can be transmitted on two or more beams each carrying the same content.

In block 536 the UE 505 monitors and/or receives one or two (or more) RARs based on the mapping. Receiving one or two RARs can be based on the number of beams used to transmit the RAR. If the UE 505 determines that two RARs may be transmitted based on the mapping of SSBs to ROs with shared PRACH preambles, the UE 505 attempts to decode both transmissions. The UE 505 communicates a message 538 to the BS510. The message 538 can be a MSG3 message. The message 538 can include an indication of a UE type (e.g., a RedCap UE type). In block 540 the BS 510 processes the received message using the best beam (if known) or both beams. If both beams are used, the BS 510 can identify the best beam based on the indicated UE type.

Some example advantages:

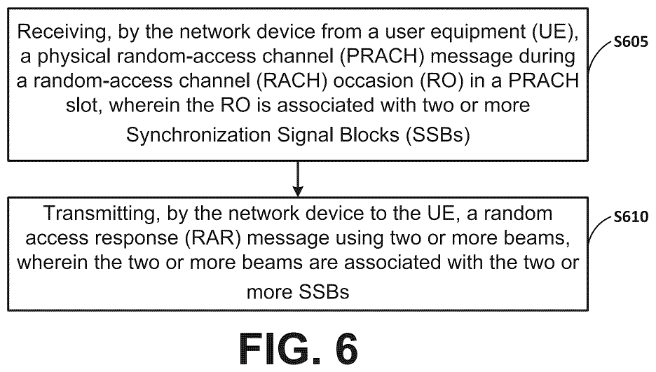

Example 1. FIG. 6 is a block diagram of a method of operating a network device according to an example embodiment. The method including, in step S605, receiving, by the network device from a user equipment (UE), a physical random-access channel (PRACH) message during a random-access channel (RACH) occasion (RO) in a PRACH slot, wherein the RO is associated with two or more Synchronization Signal Blocks (SSBs). In step S610 transmitting, by the network device to the UE, a random access response (RAR) message using two or more beams, wherein the two or more beams are associated with the two or more SSBs.

Example 2. The method of Example 1, wherein the PRACH message comprises a PRACH preamble associated with the two or more SSBs, method can further include, after receiving the PRACH message, configuring, by the network device, two or more beams corresponding to each of the two or more SSBs, to separately detect the PRACH preamble.

Example 3. The method of Example 1 or Example 2, the method can further include receiving, by the network device from the UE, a second message in response to transmitting the RAR message, the second message including a UE type indication and determining, by the network device, one beam of the two or more beams to be used for future transmissions to, and receptions from, the UE based on the UE type indication being included in the second message.

Example 4. The method of Example 1 to Example 3, a first SSB of the two or more SSBs is mapped to a PRACH preamble in a RO for a new radio (NR) UE and a second SSB of the two or more SSBs is mapped to a PRACH preamble in the RO for a reduced capability UE.

Example 5. The method of Example of any of Example 1 to Example 4, wherein the UE can be a reduced capability UE, the UE type indication can be a reduced capability UE type indication and the UE type indication is a reduced capability UE type indication.

Example 6. The method of Example of any of Example 1 to Example 5, wherein the RAR message transmitted on the two or more beams can include a same RAR information and wherein the RAR message can be transmitted on the two or more beams in different windows in time for different UE types.

Example 7. The method of Example of any of Example 1 to Example 6, can further include transmitting, by the network device, a signal indicating that the RAR message will be transmitted using a determined beam.

Example 8. The method of Example of any of Example 3 to Example 7, wherein the second message is received, and each of the two or more beams can be used to separately the received second message (the second message is sometimes called Msg3).

Example 9. The method of Example of any of Example 3 to Example 8, wherein determining the one beam of the two or more beams can include determining an SSB associated with a best beam dependent on the presence or absence of a UE type indication.

Example 10. The method of Example of any of Example 1 to Example 9, wherein the RAR message transmitted on the two or more beams can include a same RAR information.

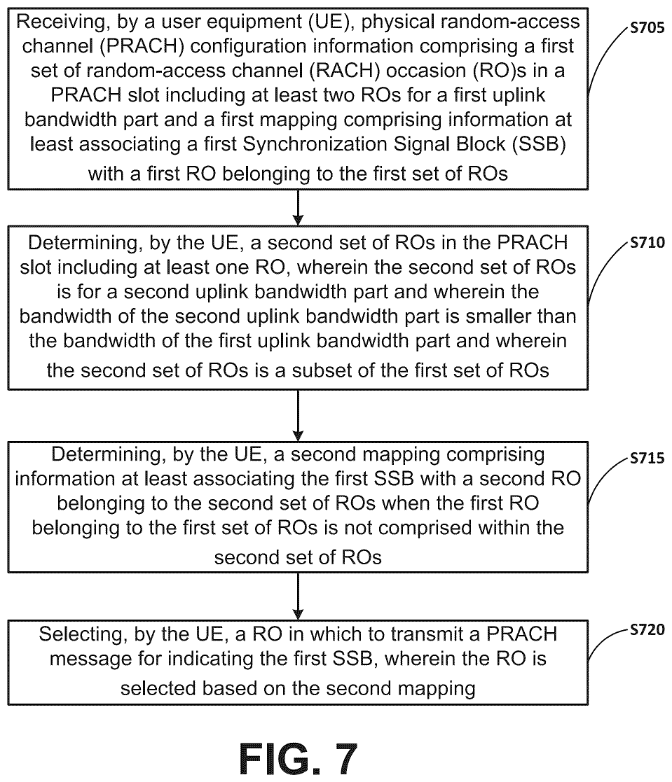

Example 11. FIG. 7 is a block diagram of a method of operating a UE according to an example embodiment. The method including, in step S705, receiving, by a user equipment (UE), physical random-access channel (PRACH) configuration information comprising a first set of random-access channel (RACH) occasion (RO)s in a PRACH slot including at least two ROs for a first uplink bandwidth part and a first mapping comprising information at least associating a first Synchronization Signal Block (SSB) with a first RO belonging to the first set of ROs. In step S710 determining, by the UE, a second set of ROs in the PRACH slot including at least one RO, wherein the second set of ROs is for a second uplink bandwidth part and wherein the bandwidth of the second uplink bandwidth part is smaller than the bandwidth of the first uplink bandwidth part and wherein the second set of ROs is a subset of the first set of ROs. In step S715 determining, by the UE, a second mapping comprising information at least associating the first SSB with a second RO belonging to the second set of ROs when the first RO belonging to the first set of ROs is not comprised within the second set of ROs. In step S720 selecting, by the UE, a RO in which to transmit a PRACH message for indicating the first SSB, wherein the RO is selected based on the second mapping.

Example 12. The method of Example 11, wherein the first mapping comprises information associating a second SSB with the second RO.

Example 13. The method of Example 11 or Example 12, wherein determining the second mapping can include determining, by the UE, a number of ROs in the first set of ROs and a number of SSBs per RO based on the PRACH configuration information and determining the number of SSBs mapped to all ROs in the PRACH slot based on the PRACH configuration information.

Example 14. The method of any of Example 11 to Example 13, wherein the UE can be a reduced capability UE and the PRACH configuration information can be associated with a new radio (NR) UE.

Example 15. The method of Example 11 to Example 14, wherein the second set of ROs in the PRACH slot is indicated by higher layer signaling.

Example 16. The method of Example 11 to Example 15, wherein determining the second mapping can include determining, by the UE, a number of ROs in the second set of ROs based on a number of ROs contained within the second uplink (UL) bandwidth-part (BWP).

Example 17. The method of Example 11 to Example 16, wherein the second mapping can include first, associating at least one SSB with at least one RO in the second set of ROs using preambles in increasing order of preamble indexes up to a maximum of a number of SSBs per RO based on the first mapping, wherein the preamble indexes are not used in the first mapping and second, associating the at least one SSB with the at least one RO in the second set of ROs in increasing order of indexes of the at least one RO in the second set of ROs.

Example 18. The method of Example 11 to Example 17, wherein when a plurality of SSBs are mapped to the second RO, associating different SSBs of the plurality of SSBs with different PRACH preamble subsets.

Example 19. The method of Example 11 to Example 18, wherein more SSBs can be associated with the second RO than with the first RO.

Example 20. The method of Example 11 to Example 19, wherein when the first SSB is determined by the UE to be the best SSB, initiating, by the UE, a random access procedure by transmitting a PRACH preamble in the second RO for indicating the first SSB.

Example 21. The method of Example 11 to Example 20, wherein when a plurality of SSBs are mapped to the second RO, receiving a plurality of RARs, wherein each RAR of the plurality of RARs is associated with an SSB of the plurality of SSBs.

Example 22. The method of Example 11 to Example 21 can further include receiving, by the UE, a Radio Access Response (RAR) message transmitted using a beam associated with an SSB, where the SSB is associated with a RO according to the second mapping, and in response to receiving the RAR message, transmitting a message including a UE type indication.

Example 23. A non-transitory computer-readable storage medium comprising instructions stored thereon that, when executed by at least one processor, are configured to cause a computing system to perform the method of any of Examples 1-22.

Example 24. An apparatus comprising means for performing the method of any of Examples 1-22.

Example 25. An apparatus comprising at least one processor and at least one memory including computer program code, the at least one memory and the computer program code configured to, with the at least one processor, cause the apparatus at least to perform the method of any of Examples 1-22.

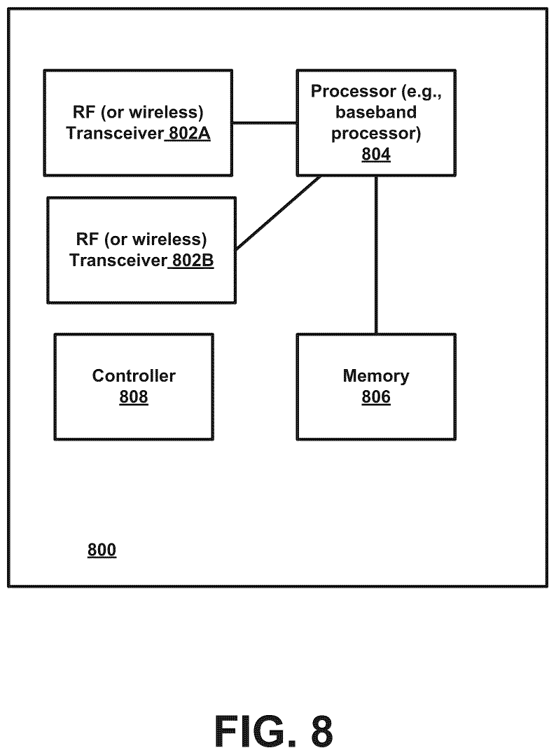

FIG. 8 is a block diagram of a wireless station 800 or wireless node or network node 800 according to an example embodiment. The wireless node or wireless station or network node 800 may include, e.g., one or more of an AP, BS, gNB, RAN node, relay node, UE or user device, network node, network entity, DU, CU-CP, CU-UP, . . . or other node) according to an example embodiment.

The wireless station 800 may include, for example, one or more (e.g., two as shown in FIG. 8) radio frequency (RF) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example embodiment, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The example embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Example embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1.-88. (canceled)

89. An apparatus comprising:
at least one processor; and
at least one memory including computer program code;
the at least one memory and the computer program code configured to, with the at least one processor, cause the apparatus to:
receive, by a network device from a user equipment (UE), a physical random-access channel (PRACH) message during a random-access channel (RACH) occasion (RO) in a PRACH slot, wherein the RO is associated with two or more Synchronization Signal Blocks (SSBs); and
transmit, by the network device to the UE, a random access response (RAR) message using two or more beams, wherein the two or more beams are associated with the two or more SSBs.

90. The apparatus of claim 89, wherein the PRACH message comprises a PRACH preamble associated with the two or more SSBs, the computer program code further causing the apparatus to:
after receiving the PRACH message, configuring, by the network device, two or more beams corresponding to each of the two or more SSBs, to separately detect the PRACH preamble.

91. The apparatus of claim 89, the computer program code further causing the apparatus to:
receive, by the network device from the UE, a second message in response to transmitting the RAR message, the second message including a UE type indication; and
determine, by the network device, one beam of the two or more beams to be used for future transmissions to, and receptions from, the UE based on the UE type indication being included in the second message.

92. The apparatus of claim 89, wherein
a first SSB of the two or more SSBs is mapped to a PRACH preamble in a RO for a new radio (NR) UE and a second SSB of the two or more SSBs is mapped to a PRACH preamble in the RO for a reduced capability UE.

93. The apparatus of claim 89, wherein
the UE is a reduced capability UE, and
the UE type indication is a reduced capability UE type indication.

94. The apparatus of claim 89, wherein the RAR message transmitted on the two or more beams comprises a same RAR information and wherein the RAR message is transmitted on the two or more beams in different windows in time for different UE types.

95. The apparatus of claim 89, the computer program code further causing the apparatus to:
transmitting, by the network device, a signal indicating that the RAR message will be transmitted using a determined beam.

96. An apparatus comprising:
at least one processor; and
at least one memory including computer program code;
the at least one memory and the computer program code configured to, with the at least one processor, cause the apparatus to:
receive, by a user equipment (UE), physical random-access channel (PRACH) configuration information comprising a first set of random-access channel (RACH) occasion (RO)s in a PRACH slot including at least two ROs for a first uplink bandwidth part and a first mapping comprising information at least associating a first Synchronization Signal Block (SSB) with a first RO belonging to the first set of ROs;
determine, by the UE, a second set of ROs in the PRACH slot including at least one RO, wherein the second set of ROs is for a second uplink bandwidth part and wherein the bandwidth of the second uplink bandwidth part is smaller than the bandwidth of the first uplink bandwidth part and wherein the second set of ROs is a subset of the first set of ROs;
determine, by the UE, a second mapping comprising information at least associating the first SSB with a second RO belonging to the second set of ROs when the first RO belonging to the first set of ROs is not comprised within the second set of ROs; and
select, by the UE, a RO in which to transmit a PRACH message for indicating the first SSB, wherein the RO is selected based on the second mapping.

97. The apparatus of claim 96, wherein the first mapping comprises information associating a second SSB with the second RO.

98. The apparatus of claim 96, wherein determining the second mapping comprises: determining, by the UE, a number of ROs in the first set of ROs and a number of SSBs per RO based on the PRACH configuration information; and
determining the number of SSBs mapped to all ROs in the PRACH slot based on the PRACH configuration information.

99. The apparatus of claim 96, wherein
the UE is a reduced capability UE, and
the PRACH configuration information is associated with a new radio (NR) UE.

100. The apparatus of claim 96, wherein the second set of ROs in the PRACH slot is indicated by higher layer signaling.

101. The apparatus of claim 96, wherein determining the second mapping comprises:
determining, by the UE, a number of ROs in the second set of ROs based on a number of ROs contained within the second uplink (UL) bandwidth-part (BWP).

102. The apparatus of claim 96, wherein determining the second mapping comprises:
first, associating at least one SSB with at least one RO in the second set of ROs using preambles in increasing order of preamble indexes up to a maximum of a number of SSBs per RO based on the first mapping, wherein the preamble indexes are not used in the first mapping; and
second, associating the at least one SSB with the at least one RO in the second set of ROs in increasing order of indexes of the at least one RO in the second set of ROs.

103. The apparatus of claim 96, wherein
when a plurality of SSBs are mapped to the second RO,
associating different SSBs of the plurality of SSBs with different PRACH preamble subsets.

104. The apparatus of claim 96, wherein more SSBs are associated with the second RO than with the first RO.

105. The apparatus of claim 96, wherein
when the first SSB is determined by the UE to be the best SSB,
initiating, by the UE, a random access procedure by transmitting a PRACH preamble in the second RO for indicating the first SSB.

106. The apparatus of claim 96, wherein
when a plurality of SSBs are mapped to the second RO, receiving a plurality of RARs, wherein each RAR of the plurality of RARs is associated with an SSB of the plurality of SSBs.

107. The apparatus of claim 96, the computer program code further causing the apparatus to:
receive, by the UE, a Radio Access Response (RAR) message transmitted using a beam associated with an SSB, where the SSB is associated with a RO according to the second mapping, and
in response to receiving the RAR message, transmit a message including a UE type indication.
with the two or more SSBs.

108. A method comprising:
receiving, by a user equipment (UE), physical random-access channel (PRACH) configuration information comprising a first set of random-access channel (RACH) occasion (RO)s in a PRACH slot including at least two ROs for a first uplink bandwidth part and a first mapping comprising information at least associating a first Synchronization Signal Block (SSB) with a first RO belonging to the first set of ROs;
determining, by the UE, a second set of ROs in the PRACH slot including at least one RO, wherein the second set of ROs is for a second uplink bandwidth part and wherein the bandwidth of the second uplink bandwidth part is smaller than the bandwidth of the first uplink bandwidth part and wherein the second set of ROs is a subset of the first set of ROs;
determining, by the UE, a second mapping comprising information at least associating the first SSB with a second RO belonging to the second set of ROs when the first RO belonging to the first set of ROs is not comprised within the second set of ROs; and
selecting, by the UE, a RO in which to transmit a PRACH message for indicating the first SSB, wherein the RO is selected based on the second mapping.
